(19) United States
(12) Patent Application Publication
(10) Pub. No.: US 2014/0156994 A1
(43) Pub. Date: Jun. 5, 2014

(54) INFORMATION PROCESSING APPARATUS AND METHOD FOR ACTIVATING COMPUTER

(71) Applicant: FUJITSU LIMITED, (US)

(72) Inventor: Shigeo SAKUMA, Yokohama (JP)

(73) Assignee: FUJITSU LIMITED, Kawasaki-shi (JP)

(21) Appl. No.: 13/887,774

(22) Filed: May 6, 2013

(30) Foreign Application Priority Data
Jul. 27, 2012 (JP) 2012-167441

(51) Int. Cl. H04L 9/00

(52) U.S. Cl. CPC H04L 9/006
USPC 713/171

(57) ABSTRACT

An information processing apparatus includes a storage unit and a processor. The storage unit stores a private key corresponding to a public key stored in a storage apparatus connected to the information processing apparatus through a network. The processor receives first data from the network. The processor decrypts second data included in the first data using the private key. The processor determines whether a result of the decryption is third data. The processor activates the information processing apparatus when the result of the decryption is the third data.

### CROSS-REFERENCE TO RELATED APPLICATION

This application is based upon and claims the benefit of priority of the prior Japanese Patent Application No. 2012-167441, filed on Jul. 27, 2012, the entire contents of which are incorporated herein by reference.

### FIELD

The embodiments discussed herein are related to an information processing apparatus and a method for activating a computer.

### BACKGROUND

Computers are installed with, for example, the following authentication functions, so that unauthorized users do not operate the computers in case of theft or the like.

A first authentication function is an authentication function using a basic input/output system (BIOS) password. That is, at the activation of a computer, authentication using a BIOS password is executed before a BIOS completes basic processing.

A second authentication function is an authentication function using a hard disk password. That is, a password is set for a hard disk itself, and access to the hard disk is not permitted unless the password is input. According to this authentication function, even if the hard disk is removed from a computer, it is difficult to obtain information from the hard disk unless a correct password is input.

A third authentication function is an authentication function using an account password of an operating system (OS). That is, even after the execution of the OS, the service of the OS is not provided unless a correct password is input.

The BIOS password and the hard disk password are saved in a BIOS chip (electrically erasable programmable read-only memory; EEPROM) and a control board of a hard disk or the like, respectively, in which the saved information is not easily decrypted or erased, and therefore even if a computer is stolen, it is often difficult to decrypt the passwords or break the authentication functions.

On the other hand, because the authentication function using the account password of the OS is a function of the OS, it is likely that the authentication function is broken due to existence of a security hole or the like. In addition, even before the account password is input, the service of the OS has already begun. Therefore, for example, there is a risk that important information is obtained without authentication as a result of access to a file through a network or the like.

On the other hand, there is a technology called “Wake-on-LAN”. Wake-on-LAN is a technology for enabling control of power to a computer through a remote operation using a local area network (LAN). In general, a packet called a “magic packet” is used in Wake-on-LAN. The magic packet is a packet including a media access control (MAC) address of a computer to be activated. Power is supplied to a LAN controller of a computer capable of Wake-on-LAN even when the computer is not activated. Upon receiving a magic packet, the LAN controller compares the MAC address included in the magic packet with a MAC address thereof. If the two match, the LAN controller outputs an activation signal to the computer. Upon receiving the activation signal, the computer begins to operate.

When a BIOS password or a hard disk password is set in the case of using Wake-on-LAN, a user is supposed to input the BIOS password or the hard disk password to a computer to be activated. In this case, convenience of the remote operation using Wake-on-LAN is undesirably lost. Therefore, computers are usually set to disable the BIOS password and the hard disk password in the case of activation using Wake-on-LAN.

Japanese Laid-open Patent Publication No. 2000-242372 and Japanese Laid-open Patent Publication No. 11-85326 disclose related techniques.

However, a MAC address is often described, for example, inside a computer or on a board, and may be found easily. Therefore, it is not difficult for a thief who has stolen a computer to generate a magic packet for activating the computer.

As described above, in the case of activation using a magic packet, a BIOS password and a hard disk password are usually disabled. In addition, even if an account password of an OS is used, the security level is not high.

As a result, information stored in a stolen computer is likely to leak easily by using Wake-on-LAN.

### SUMMARY

According to an aspect of the present invention, provided is an information processing apparatus including a storage unit and a processor. The storage unit stores a private key corresponding to a public key stored in a storage apparatus connected to the information processing apparatus through a network. The processor receives first data from the network. The processor decrypts second data included in the first data using the private key. The processor determines whether a result of the decryption is third data. The processor activates the information processing apparatus when the result of the decryption is the third data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a system configuration under a normal condition according to an embodiment;

FIG. 2 is a diagram illustrating an example of a hardware configuration of a server apparatus according to an embodiment;

FIG. 3 is a diagram illustrating an example of a functional configuration of each apparatus according to a first embodiment;

FIG. 4 is a flowchart illustrating an example of a processing procedure executed by a client apparatus according to a first embodiment;

FIG. 5 is a diagram illustrating an example of a structure of data included in a magic packet;

FIG. 6 is a flowchart illustrating an example of a processing procedure executed by an interface device of a server apparatus according to a first embodiment;

FIG. 7 is a flowchart illustrating an example of a processing procedure of an activation process executed by a server apparatus according to a first embodiment;

FIG. 8 is a diagram illustrating an example of a functional configuration of each apparatus according to a second embodiment;

FIG. 9 is a flowchart illustrating an example of a processing procedure executed by an interface device of a server apparatus according to a second embodiment;

FIG. 10 is a flowchart illustrating an example of a processing procedure of an activation process executed by a server apparatus according to a second embodiment;

FIG. 11 is a diagram illustrating an example of a functional configuration of each apparatus according to a third embodiment; and

FIG. 12 is a flowchart illustrating an example of a processing procedure of an activation process executed by a server apparatus according to a third embodiment.

### DESCRIPTION OF EMBODIMENTS

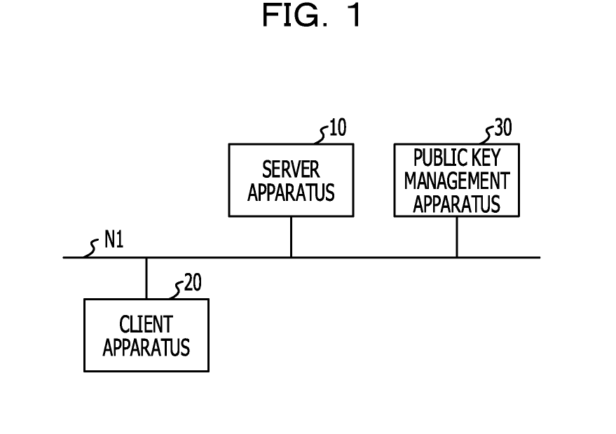

Embodiments will be described hereinafter with reference to the drawings. FIG. 1 is a diagram illustrating an example of a system configuration under a normal condition according to an embodiment. The normal condition refers to a condition under which a client apparatus 20 is used by an authorized user in a proper use environment.

In FIG. 1, a server apparatus 10, the client apparatus 20, a public key management apparatus 30, and the like are communicably connected to one another through a network N1 such as a LAN.

The server apparatus 10 is an example of a computer to be activated using Wake-on-LAN. The client apparatus 20 is an example of a computer that remotely controls power to the server apparatus 10 using Wake-on-LAN. That is, the client apparatus 20 broadcasts, to the network N1, a magic packet in which the server apparatus 10 is specified as a target to be activated. The server apparatus 10 performs an activation process upon receiving the magic packet.

The public key management apparatus 30 is an example of a computer that stores a public key corresponding to a private key stored in the server apparatus 10. The public key is used by the client apparatus 20 to generate a magic packet. The private key and the public key are cryptographic keys used in a public-key cryptosystem.

The public key management apparatus 30 is desirably installed in a place different from a place in which the server apparatus 10 is installed. The different place is a place, such as a different floor or the like, in which it is difficult to visually recognize the server apparatus 10 together with the public key management apparatus 30. In addition, the public key management apparatus 30 is desirably installed in a safe place. The safe place is a place, for example, into which only a particular person such as an administrator is permitted to enter.

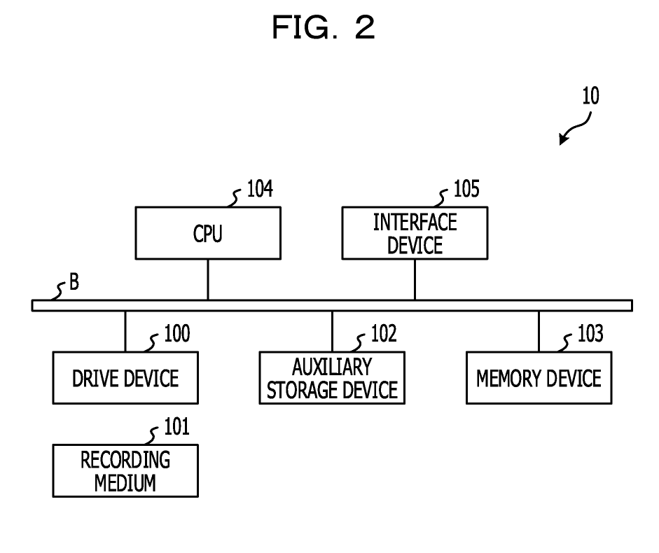

FIG. 2 is a diagram illustrating an example of a hardware configuration of a server apparatus according to an embodiment. The server apparatus 10 illustrated in FIG. 2 includes a drive device 100, an auxiliary storage device 102, a memory device 103, a central processing unit (CPU) 104, and an interface device 105, connected to one another through a bus B.

A program for realizing processing in the server apparatus 10 is provided by a recording medium 101. When the recording medium 101 on which the program is recorded has been set in the drive device 100, the program is installed in the auxiliary storage device 102 from the recording medium 101 through the drive device 100. However, the program does not have to be installed from the recording medium 101, and may be downloaded from another computer through a network. The auxiliary storage device 102 stores the installed program, as well as files and data and the like to be used.

Upon receiving an instruction to execute the program, the memory device 103 stores the program read from the auxiliary storage device 102. The CPU 104 executes a function relating to the server apparatus 10 in accordance with the program stored in the memory device 103. The interface device 105 is hardware used as an interface for connecting to the network. As an example of the interface device 105, a LAN controller, a LAN card, or the like may be used. The LAN card is an expansion card including a LAN controller. In the embodiments, a single MAC address is assigned to a single interface device 105.

As an example of the recording medium 101, a portable recording medium such as a compact disc read-only memory (CD-ROM), a digital versatile disc (DVD), a Universal Serial Bus (USB) memory, or the like may be used. As an example of the auxiliary storage device 102, a hard disk drive (HDD), a flash memory, or the like may be used. The recording medium 101 and the auxiliary storage device 102 correspond to computer-readable recording media.

The client apparatus 20 and the public key management apparatus 30 may include similar hardware to that illustrated in FIG. 2.

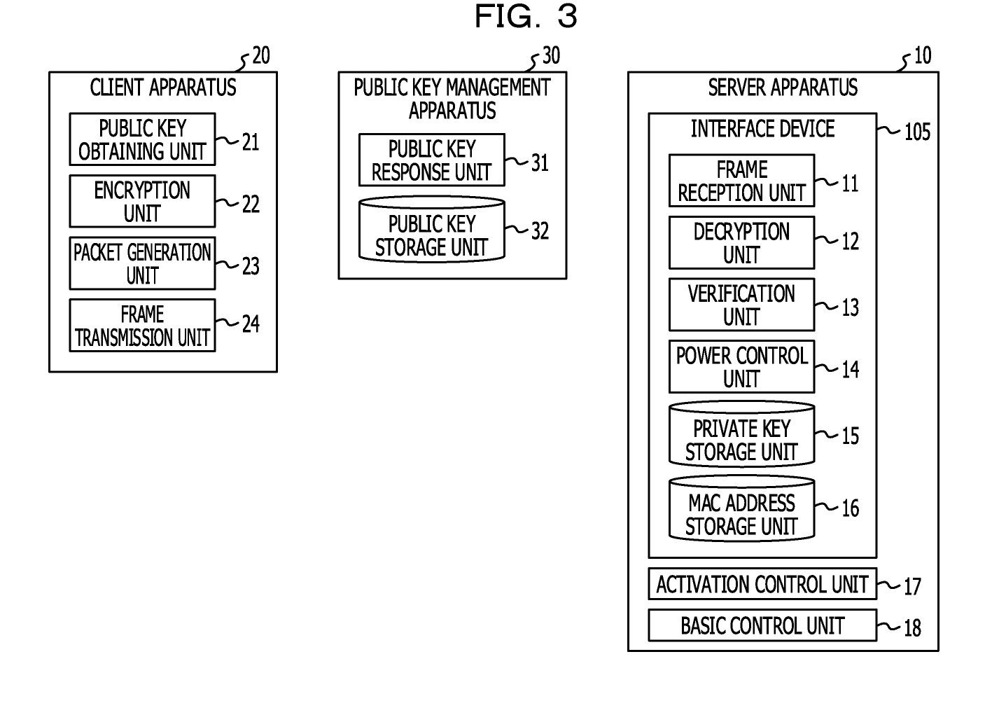

FIG. 3 is a diagram illustrating an example of a functional configuration of each apparatus according to a first embodiment. In FIG. 3, the public key management apparatus 30 includes a public key response unit 31 and a public key storage unit 32. The public key storage unit 32 stores a public key corresponding to a private key stored in the server apparatus 10. The public key storage unit 32 may be realized, for example, by using an auxiliary storage device or the like of the public key management apparatus 30. Upon receiving a request to obtain a public key from the client apparatus 20, the public key response unit 31 sends back the public key stored in the public key storage unit 32. The public key response unit 31 is realized, for example, by a CPU of the public key management apparatus 30 by executing one or more programs installed in the public key management apparatus 30.

The client apparatus 20 includes a public key obtaining unit 21, an encryption unit 22, a packet generation unit 23, and a frame transmission unit 24. These components are realized, for example, by a CPU of the client apparatus 20 by executing one or more programs installed in the client apparatus 20.

The public key obtaining unit 21 obtains a public key from the public key management apparatus 30. The encryption unit 22 encrypts a MAC address (hereinafter referred to as a “client MAC address”) of an interface device (LAN controller) of the client apparatus 20 using the public key obtained by the public key obtaining unit 21. The packet generation unit 23 generates a magic packet for activating the server apparatus 10. At this time, the packet generation unit 23 includes, in the magic packet, the client MAC address encrypted by the encryption unit 22. The frame transmission unit 24 transmits a frame including the magic packet generated by the packet generation unit 23 to the network N1. The frame refers to a data unit in a data link layer.

The interface device 105 of the server apparatus 10 includes a frame reception unit 11, a decryption unit 12, a verification unit 13, and a power control unit 14. These components may be circuits included in the interface device 105 or may be realized by a CPU of the interface device 105 by executing a program stored in a storage unit included in the interface device 105. The interface device 105 further includes a private key storage unit 15 and a MAC address storage unit 16. These storage units may be realized by using a storage unit included in the interface device 105.

The private key storage unit 15 stores a private key corresponding to a public key stored in the public key management apparatus 30. The MAC address storage unit 16 stores a MAC address of the interface device 105.

The frame reception unit 11 receives a frame from the network N1. When a magic packet is included in the frame received by the frame reception unit 11, the decryption unit 12 decrypts an encrypted client MAC address included in the magic packet using the private key stored in the private key storage unit 15. The verification unit 13 determines whether or not the decryption is successful by comparing the decrypted client MAC address with a source MAC address of the received frame. As a result of the determination as to whether or not the decryption is successful, whether or not the source of the magic packet possesses a correct public key is verified. If the decryption is successful, that is, if it is verified that the source of the magic packet possesses a correct public key, the power control unit 14 outputs a power activation signal to the server apparatus 10.

Even when power is not supplied to the server apparatus 10 itself, power is supplied to the interface device 105. Therefore, the interface device 105 may operate even while the server apparatus 10 is stopped.

The server apparatus 10 further includes an activation control unit 17 and a basic control unit 18. Upon receiving an activation instruction, the activation control unit 17 controls activation process of the server apparatus 10. An example of the activation instruction may be pressing of a power button, output of a power activation signal from the interface device 105, or the like. The activation control unit 17 is realized, for example, by the CPU 104 by executing a program such as firmware installed in the server apparatus 10. The firmware may include, for example, a boot loader.

When the activation process of the server apparatus 10 has been completed, the basic control unit 18 provides a basic service for the server apparatus 10 executing programs for various processes. The basic control unit 18 is realized, for example, by the CPU 104 by executing a program such as an operating system (OS) installed in the server apparatus 10.

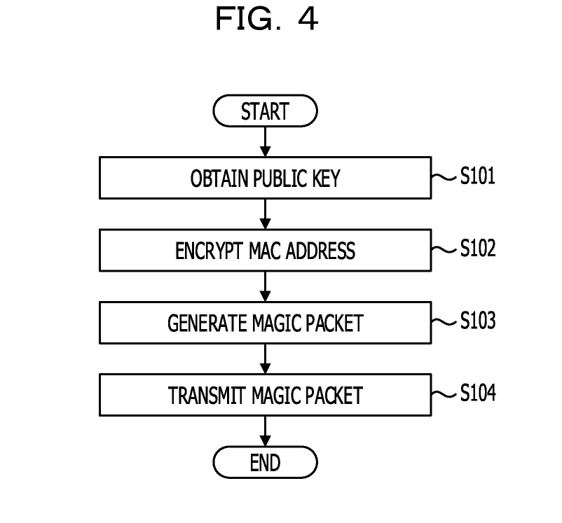

Processing procedures executed by the client apparatus 20 and the server apparatus 10 in the first embodiment will be described hereinafter. FIG. 4 is a flowchart illustrating an example of a processing procedure executed by a client apparatus in the first embodiment. The processing illustrated in FIG. 4 begins when, for example, a user has input an instruction, when it has been detected that the time has come, or the like.

In S101, the public key obtaining unit 21 obtains a public key from the public key management apparatus 30. More specifically, the public key obtaining unit 21 transmits a request to obtain a public key to the public key management apparatus 30. The public key response unit 31 of the public key management apparatus 30 sends back the public key stored in the public key storage unit 32 in response to the request. The public key obtaining unit 21 receives the sent public key.

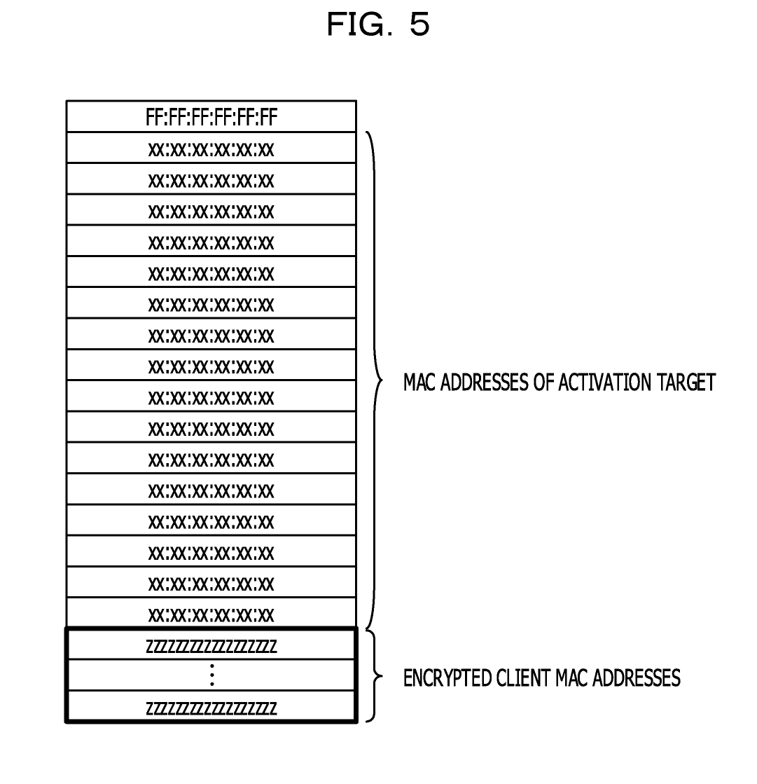

Next, the encryption unit 22 encrypts a MAC address (client MAC address) of the client apparatus 20 using the public key (S102). Next, the packet generation unit 23 generates a magic packet (S103). The payload of the generated magic packet includes, for example, data having a structure illustrated in FIG. 5.

FIG. 5 is a diagram illustrating an example of a structure of data included in a magic packet. The data illustrated in FIG. 5 repeatedly includes the MAC address of the server apparatus 10 to be activated sixteen times after “FF:FF:FF:FF:FF:FF”. This is the same as in the case of a general magic packet. According to the present embodiment, furthermore, for example, an encrypted client MAC address is repeatedly included in the end of the data one or more times. Although the same encrypted client MAC address is included a plurality of times in FIG. 5, the number of encrypted client MAC addresses included may be 1, instead.

Next, the frame transmission unit 24 transmits a frame whose data field includes the magic packet including the data illustrated in FIG. 5 to the network N1 (S104). A known format may be used for the frame. For example, either DIX Ethernet or IEEE 802.3 may be used as the format.

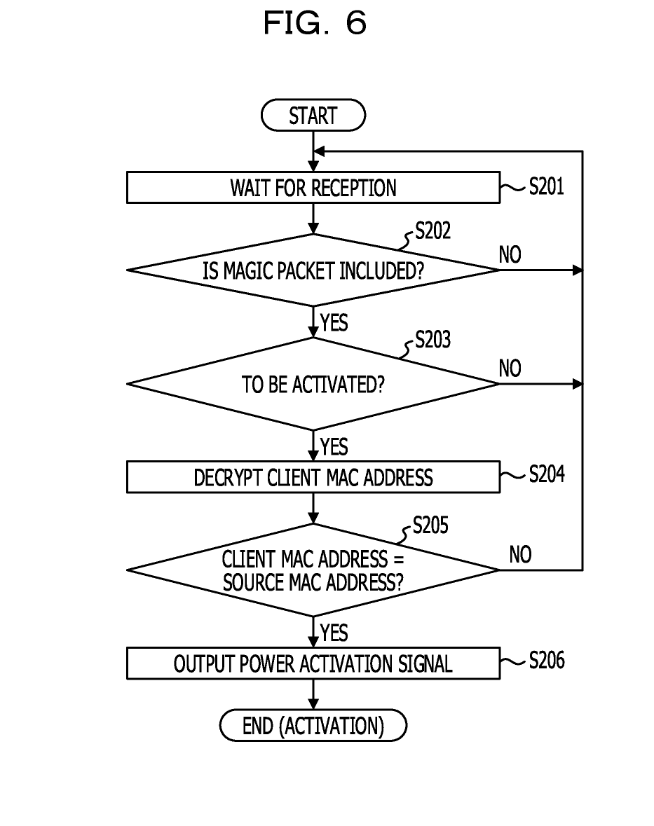

Next, a processing procedure executed by the server apparatus 10 will be described. FIG. 6 is a flowchart illustrating an example of a processing procedure executed by an interface device of a server apparatus according to the first embodiment.

The frame reception unit 11 waits for reception of a frame from the network N1 (S201). When a magic packet is included in the received frame (YES in S202), the frame reception unit 11 compares a MAC address of an activation target repeatedly included in the magic packet with a MAC address stored in the MAC address storage unit 16 (S203). That is, it is determined whether or not the target to be activated using the magic packet is the server apparatus 10. When the two match (YES in S203), the decryption unit 12 decrypts the encrypted client MAC address included in the magic packet (S204).

Next, the verification unit 13 compares the decrypted client MAC address with a source MAC address included in a header of the frame including the magic packet (S205). When the two match (YES in S205), the power control unit 14 outputs a power activation signal through, for example, the bus B (S206). As a result, power is supplied to the server apparatus 10. When the two do not match (NO in S205), the power control unit 14 does not output the power activation signal. Therefore, power is not supplied to the server apparatus 10.

Next, the activation process executed by the server apparatus 10 in response to the supply of power will be described.

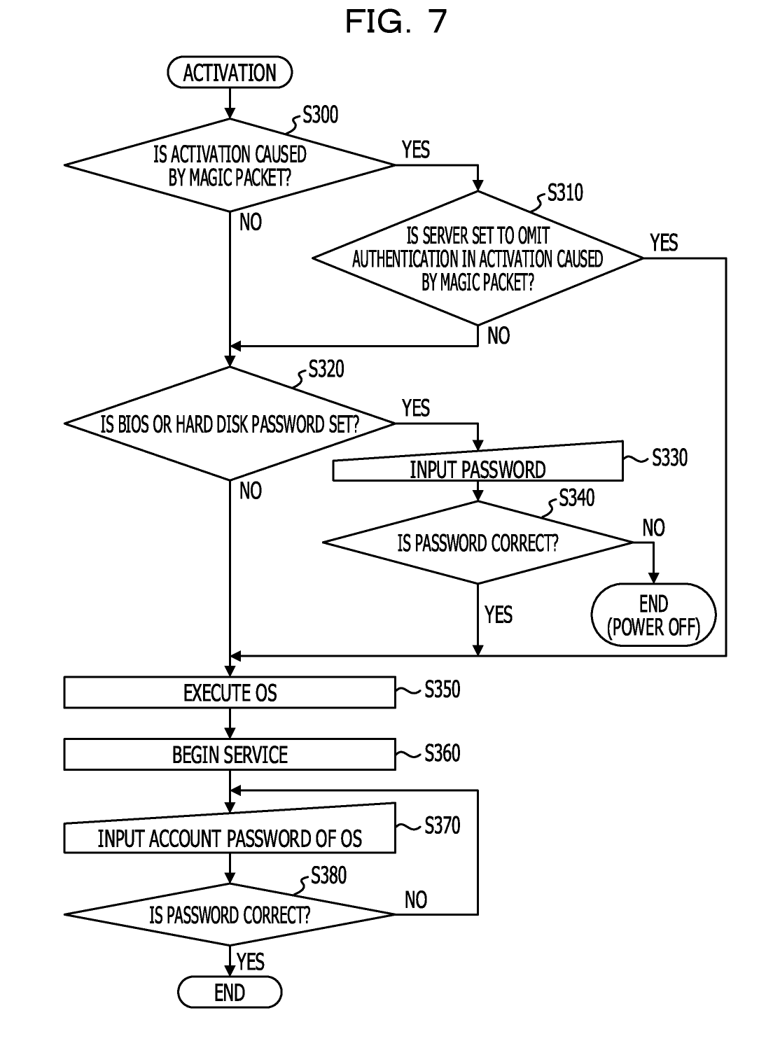

FIG. 7 is a flowchart illustrating an example of a processing procedure of an activation process executed by a server apparatus according to the first embodiment.

For example, when power has been supplied to the server apparatus 10 in response to a power activation signal from the interface device 105 that has received a magic packet, the activation control unit 17 determines whether or not the cause of the activation is reception of a magic packet (S300). The determination may be made by, for example, referring to a storage unit in the interface device 105. When the interface device 105 has output a power activation signal in response to a magic packet, information indicating the operation is stored in the storage unit.

When the activation has been caused by a magic packet (YES in S300), the activation control unit 17 determines whether or not the server apparatus 10 is set to omit, in the case of activation caused by a magic packet, authentication using a BIOS password and a hard disk password (S310). The determination may be made by referring to setting information relating to the BIOS password and the hard disk password.

When the server apparatus 10 is set to omit authentication using a BIOS password and a hard disk password (YES in S310), the procedure proceeds to S350. When the server apparatus 10 is not set to omit authentication using a BIOS password and a hard disk password (NO in S310), the activation control unit 17 determines whether or not a BIOS password, a hard disk password are set (S320). When none of the passwords is set (NO in S320), the procedure proceeds to S350. When any password is set (YES in S320), the activation control unit 17 receives input of the password from the user (S330). For example, a BIOS password or a hard disk password, or both, is input by the user.

Next, the activation control unit 17 determines whether or not the input password is correct (S340). When the input password is not correct (NO in S340), the activation process ends. When the input password is correct (YES in S340), the procedure proceeds to S350.

The activation control unit 17 loads an OS from the auxiliary storage device 102 and the OS is executed (S350). As a result, the basic control unit 18 is realized.

The basic control unit 18 begins a service (S360). For example, access to a file through a network or the like is enabled. When a user name and a password have been input in a login screen (S370), the basic control unit 18 determines whether or not the input user name and password are correct (S380). When the input user name and password are correct (YES in S380), the basic control unit 18 begins a dialog service while determining the user relating to the user name as a login user. When the input user name or password is not correct (NO in S380), the basic control unit 18 continues to display the login screen.

As described above, according to the first embodiment, the server apparatus 10 is activated when a client MAC address encrypted using a public key stored in the public key management apparatus 30 is included in the received magic packet. The public key is not stored in the server apparatus 10. Therefore, even if the server apparatus 10 is stolen, a possibility that a thief activates the server apparatus 10 using Wake-on-LAN may be reduced insofar as the thief does not obtain the public key stored in the public key management apparatus 30. Even if a private key is obtained from the server apparatus 10, it is difficult to generate a correct magic packet because a result of encryption by the private key is different from a result of encryption by the public key. Therefore, safety in activation through a network may be improved.

That is, according to the present embodiment, the authenticity of the client apparatus 20 is proved when the client apparatus 20 possesses a public key stored in the public key management apparatus 30. Therefore, information encrypted using the public key does not have to be a client MAC address, and may be information which is available to the server apparatus 10 as a target to be matched with a result obtained by decryption using the private key. For example, the information may be the MAC address of the server apparatus 10, another fixed value, a date, or the like. However, as in the present embodiment, when the target to be encrypted using the public key is data included in a frame including a magic packet, the server apparatus 10 does not have to store in advance a value to be compared, and accordingly a load caused by a setting operation may be reduced.

In addition, according to the present embodiment, information unique to the client apparatus 20 does not have to be registered to the server apparatus 10 in advance.

Next, a second embodiment will be described. In the second embodiment, differences from the first embodiments will be described. Therefore, points that are not particularly mentioned may be similar to those in the first embodiment.

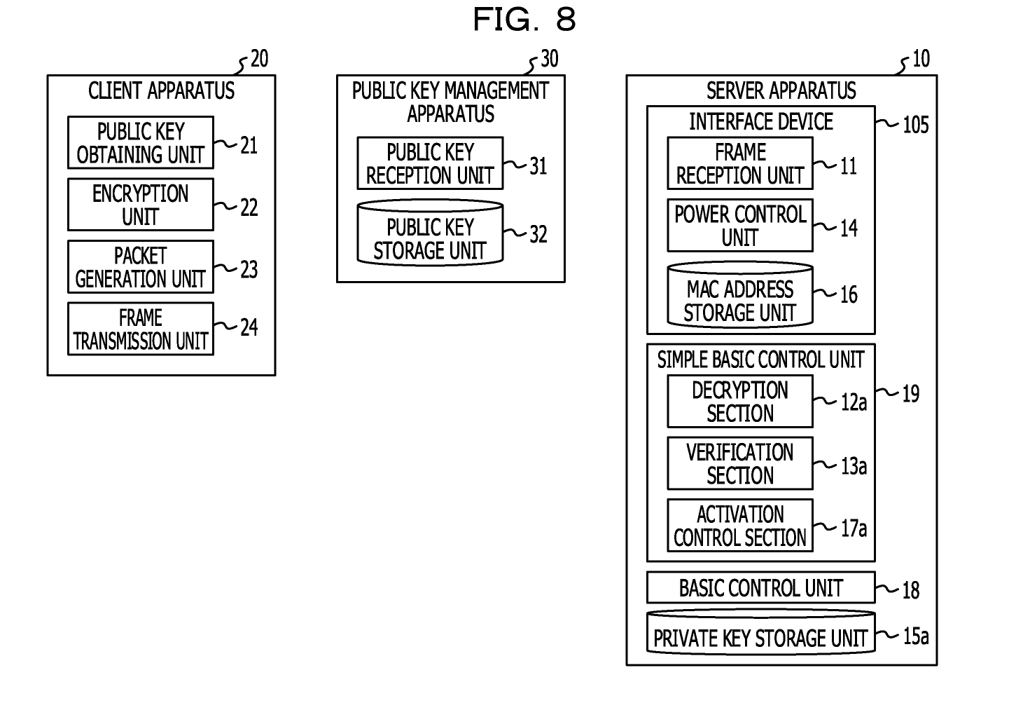

FIG. 8 is a diagram illustrating an example of a functional configuration of each apparatus according to the second embodiment. In FIG. 8, similar components to those illustrated in FIG. 3 are given similar reference numerals, and description thereof is omitted. In the second embodiment, a functional configuration relating to a server apparatus 10 is different from that in the first embodiment.

In FIG. 8, the server apparatus 10 includes a simple basic control unit 19. The simple basic control unit 19 is realized, for example, by the CPU 104 by executing a program (hereinafter referred to as a simple OS) for performing a process in response to a magic packet. Alternatively, the activation control unit 17 according to the first embodiment may have a similar function as the simple basic control unit 19.

The simple basic control unit 19 includes a decryption section 12a, a verification section 13a, and an activation control section 17a. Functions of these components are similar to those of the decryption unit 12, the verification unit 13, and the activation control unit 17, respectively.

The server apparatus 10 further includes a private key storage unit 15a. The private key storage unit 15a is realized, for example, by using an auxiliary storage device 102 or the like.

According to the second embodiment, an interface device 105 may include a frame reception unit 11, a power control unit 14, and a MAC address storage unit 16, which are included in a general LAN controller or the like.

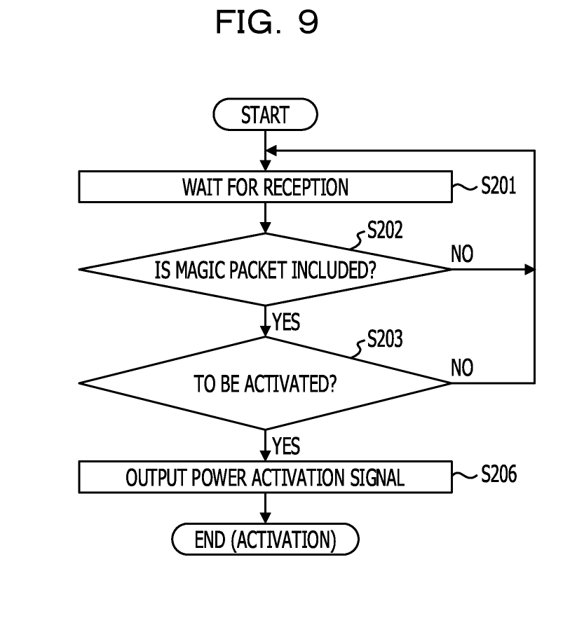

A processing procedure executed by the server apparatus 10 according to the second embodiment will be described hereinafter. FIG. 9 is a flowchart illustrating an example of a processing procedure executed by an interface apparatus of a server apparatus according to the second embodiment. In FIG. 9, similar processing to that illustrated in FIG. 6 is given a similar reference numeral, and description thereof is omitted.

FIG. 9 is different from FIG. 6 in that S204 and S205 are not executed. That is, according to the second embodiment, the interface device 105 outputs a power activation signal upon receiving a magic packet for activating the server apparatus 10.

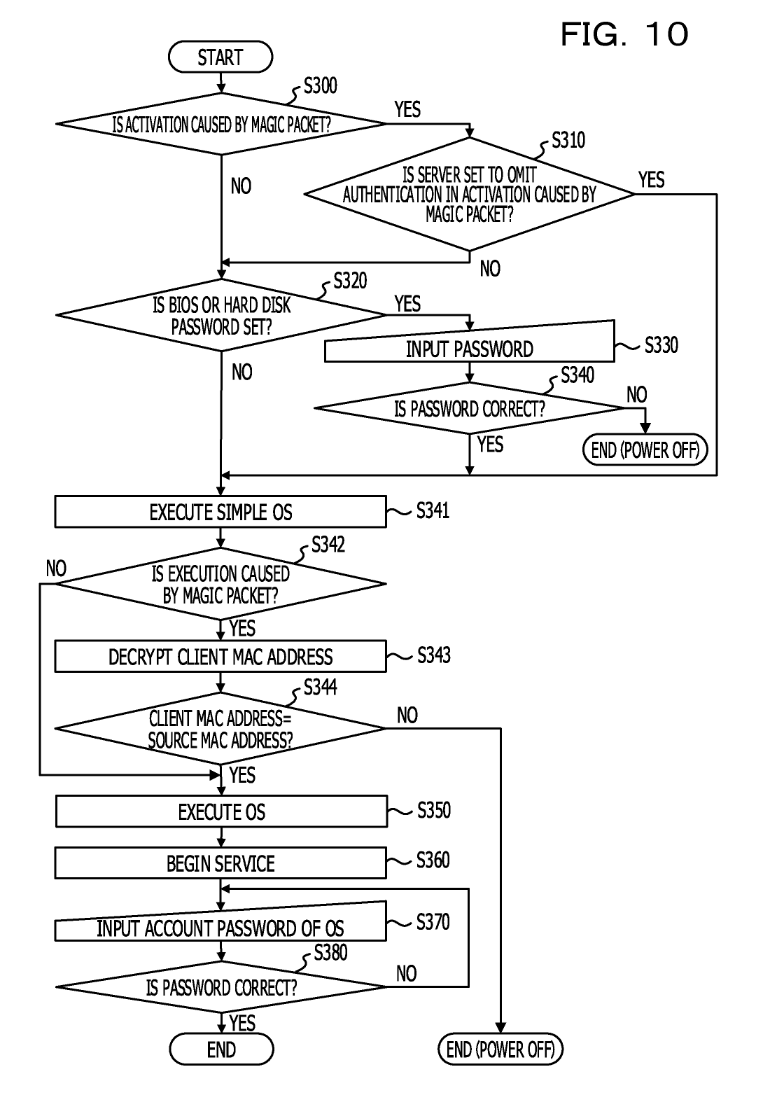

FIG. 10 is a flowchart illustrating an example of a processing procedure of an activation process executed by a server apparatus according to the second embodiment. In FIG. 10, similar processing to that illustrated in FIG. 7 is given a similar reference numeral, and description thereof is omitted.

In FIG. 10, S341 to S344 are added before S350 (execution of the OS).

A simple OS that causes the server apparatus 10 to function as the simple basic control unit 19 is executed (S341). Next, the simple basic control unit 19 determines whether or not the execution is caused by a magic packet (S342). The method for making the determination may be, for example, similar to that in S300. When the execution is not caused by a magic packet (NO in S342), the procedure proceeds to S350.

When the execution is caused by a magic packet (YES in S342), the decryption section 12a decrypts an encrypted client MAC address included in the magic packet (S343). The magic packet is obtained from a LAN controller.

Next, the verification section 13a compares the decrypted client MAC address with a source MAC address included in a header of a frame including the magic packet (S344). When the two match (YES in S344), S350 is executed. That is, the activation control section 17a causes an OS, which causes the server apparatus 10 to function as the basic control unit 18, to be executed.

When the two do not match (NO in S344), the activation process ends. As a result, power that has been supplied to the server apparatus 10 is turned off.

As described above, according to the second embodiment, even if power is supplied to the server apparatus 10 in response to a magic packet from a client apparatus 20 that does not include a public key, the power is turned off before the OS is executed. Therefore, even if the server apparatus 10 is stolen, a possibility that a thief activates the server apparatus 10 using Wake-on-LAN and obtains information may be reduced insofar as the thief does not obtain the public key stored in the public key management apparatus 30.

In addition, the necessity to modify or alter the interface device 105 and a general OS in order to realize the functions unique to the present embodiment is low.

Next, a third embodiment will be described. In the third embodiment, differences from the first or second embodiment will be described. Therefore, points that are not particularly mentioned may be similar to those in the first or second embodiment.

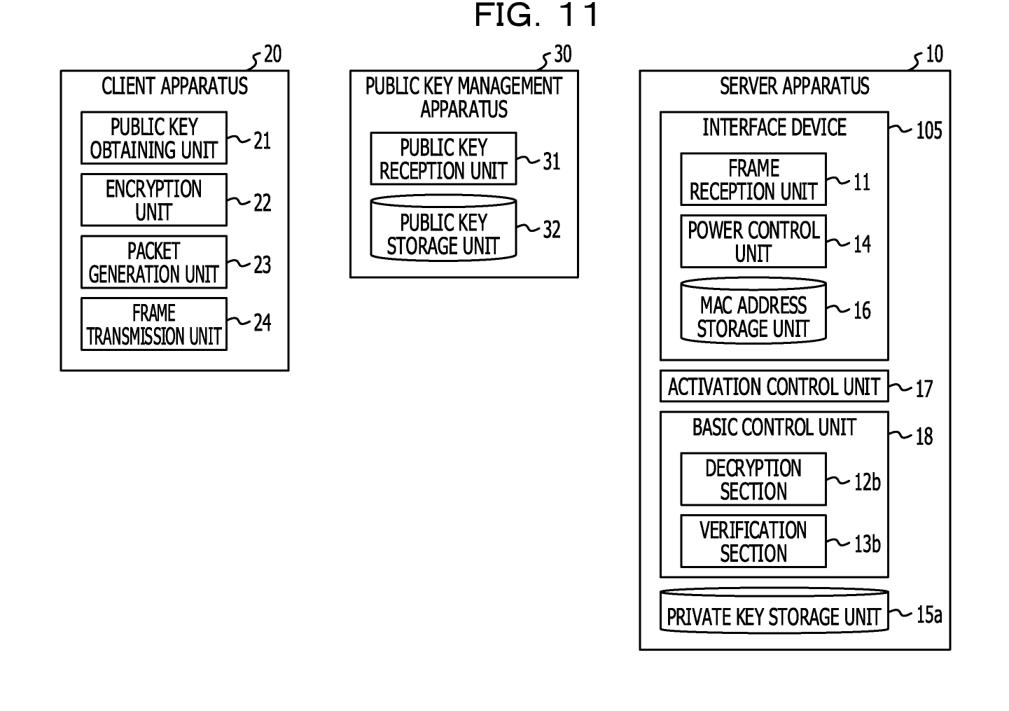

FIG. 11 is a diagram illustrating an example of a functional configuration of each apparatus according to the third embodiment. In FIG. 11, similar components to those illustrated in FIG. 3 or FIG. 8 are given similar reference numerals, and description thereof is omitted. In the third embodiment, a functional configuration relating to a server apparatus 10 is different from that in the first or second embodiment.

In FIG. 11, a basic control unit 18 includes a decryption section 12b and a verification section 13b. These components have similar functions to the decryption unit 12 and the verification unit 13, respectively, according to the first embodiment.

A processing procedure executed by the server apparatus 10 according to the third embodiment will be described hereinafter. In the third embodiment, the processing procedure executed by an interface device 105 of the server apparatus 10 may be similar to that in the second embodiment.

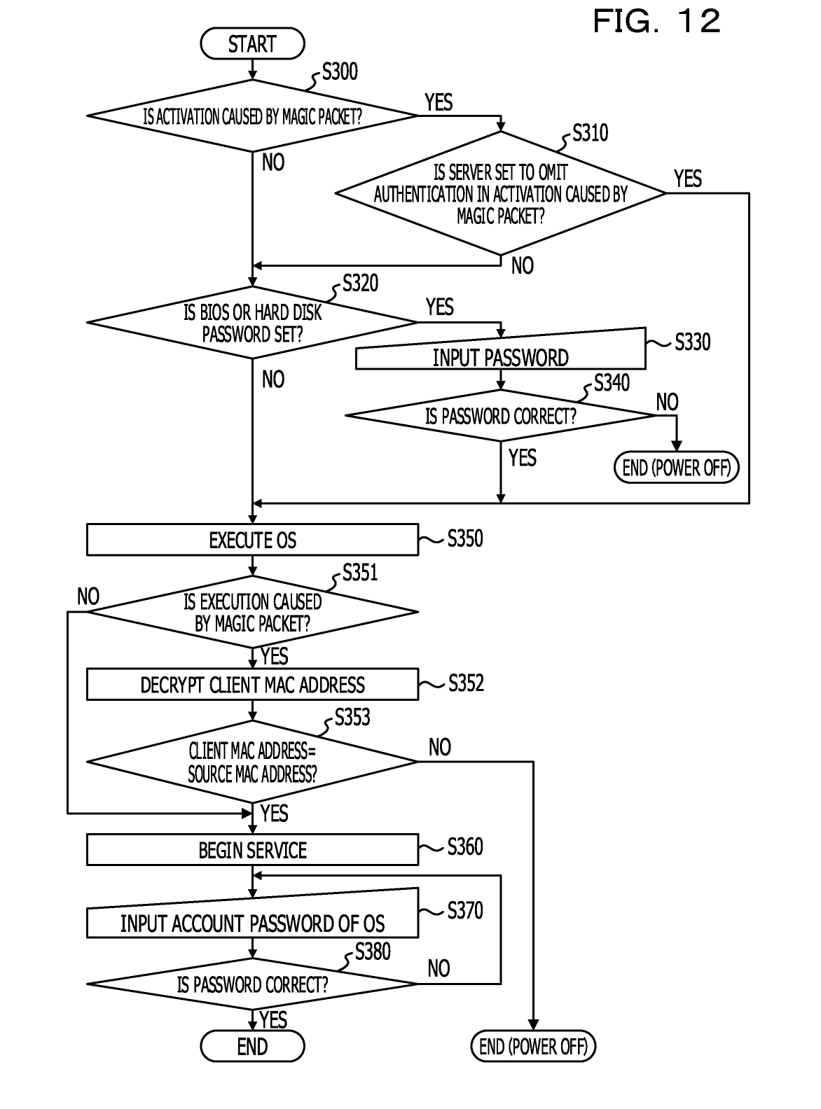

FIG. 12 is a flowchart illustrating an example of a processing procedure executed by a server apparatus according to the third embodiment. In FIG. 12, similar processing to that illustrated in FIG. 7 is given a similar reference numeral, and description thereof is omitted.

In FIG. 12, S351 to S353 are added after S350.

When an OS is executed, the basic control unit 18 determines whether or not the execution is caused by a magic packet (S351). The method for making the determination may be, for example, similar to that in S300. When the execution is not caused by a magic packet (NO in S351), the procedure proceeds to S360.

When the execution is caused by a magic packet (YES in S351), the decryption section 12b decrypts an encrypted client MAC address included in the magic packet (S352). The magic packet is obtained from a LAN controller.

Next, the verification section 13b compares the decrypted client MAC address with a source MAC address included in a header of a frame including the magic packet (S353). When the two match (YES in S353), S360 is executed. That is, the basic control unit 18 begins a service.

When the two do not match (NO in S353), the activation process ends. As a result, power that has been supplied to the server apparatus 10 is turned off.

As described above, according to the third embodiment, even if power is supplied to the server apparatus 10 in response to a magic packet from the client apparatus 20 that does not include a public key, the power is turned off before the a service described in the OS begins. Therefore, even if the server apparatus 10 is stolen, a possibility that a thief activates the server apparatus 10 using Wake-on-LAN and obtains information may be reduced insofar as the thief does not obtain the public key stored in the public key management apparatus 30.

In the above embodiments, a combination between a private key and a public key may be different for each server apparatus 10. In this case, the public key management apparatus 30 may store the public key for each server apparatus 10 while associating each public key with identification information regarding each server apparatus 10. The client apparatus 20 may obtain one of the public keys from the public key management apparatus 30 by specifying the identification information regarding the server apparatus 10 to be activated.

In the above embodiments, the private key storage unit 15 and the private key storage unit 15a are examples of a storage unit. The frame reception unit 11 is an example of a reception unit. The decryption unit 12 and the decryption sections 12a and 12b are examples of a decryption unit. The verification unit 13 and the verification sections 13a and 13b are examples of a determination unit. The magic packet is an example of certain data. The source MAC address is an example of information received along with the certain data.

Although the embodiments have been described above, the technology disclosed herein is not limited to these particular embodiments and may be modified and altered in various ways without deviating from the scope thereof described herein.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a storage unit to store a private key corresponding to a public key stored in a storage apparatus connected to the information processing apparatus through a network; and
a processor to
receive first data from the network,
decrypt second data included in the first data using the private key,
determine whether a result of the decryption is third data, and
activate the information processing apparatus when the result of the decryption is the third data.

2. The information processing apparatus according to claim 1, wherein
the third data is included in the first data.

3. A method for activating a computer, the method comprising:
receiving first data from a network;
decrypting, by a processor included in the computer, second data included in the first data using a private key corresponding to a public key stored in a storage apparatus connected to the computer through the network;
determining whether a result of the decryption is third data; and
activating the computer when the result of the decryption is the third data.

4. The method according to claim 3, wherein
the third data is included in the first data.

5. A computer-readable recording medium storing a program that causes a processor included in a computer to execute a procedure, the procedure comprising:
receiving first data from a network;
decrypting second data included in the first data using a private key corresponding to a public key stored in a storage apparatus connected to the computer through the network;
determining whether a result of the decryption is third data; and
activating the computer when the result of the decryption is the third data.

6. The computer-readable recording medium according to claim 5, wherein
the third data is included in the first data.
